(19) United States
(12) Patent Application Publication
(10) Pub. No.: US 2005/0261848 A1
(43) Pub. Date: Nov. 24, 2005

(54) System and method for classifying restoration of paper collectibles

(76) Inventor: Tracey Heft, Manitoba (CA)

Correspondence Address: ADE & COMPANY, 1700-360 Main St., Winnipeg, MB, R3C S73, CA

(21) Appl. No.: 11/131,272

(22) Filed: May 18, 2005

Related U.S. Application Data
(60) Provisional application No. 60/572,119, filed on May 19, 2004.

(51) Int. Cl. G06F 19/00

(52) U.S. Cl. 702/81

(57) ABSTRACT

A method of assigning a score to a restored paper collectible based on the quantity and quality of restoration procedures is herein described.

### PRIOR APPLICATION INFORMATION

This application claims benefit of U.S. Provisional Application 60/572,119, filed May 19, 2004.

### BACKGROUND OF THE INVENTION

Through the 1980's and 1990's a basic system of classifying restoration began to emerge. Retailers introduced this system in an attempt to describe, in an efficient manner, the extent of a paper collectible item's restoration. The terminology at the time employed the terms minor, moderate and major to describe the restoration an item had received. Later, with time, the words professional and amateur were also used. While qualitative in nature, these terms have long defied definition and provide no quantifiable data, leaving the prospective buyer and some sellers asking many more questions including how much restoration is needed to qualify as minor and what is considered professional or amateur?

In 1984, I put forward the International Institute of Conservation's definitions of preservation, conservation and restoration to replace the concept of minor, moderate and major. Presented, once again, are those definitions:
Preservation: the steps taken to ensure that an item maintains it's current condition, usually non-intrusive to the artifact or item itself.
Conservation: treatments used to prevent existing damage from proceeding further, thereby maintaining an item's current condition for the future.
Restoration: any attempts to return an object to its original form and purpose, in the attempt to recreate an earlier known state or condition.

The hobby has attempted to define restoration in various forms including anything that is added to the book as well as anything that changes the book's condition. Those attempts are basically correct, but the problem with such general terms is that conservation and those treatments that result in an improved, more stable book are often treated as restoration when, in fact, they are conservation and/or preservation steps—and should not be categorized in the same way as restoration as they do not alter the books originality (much like restoration can) but instead improve the stability of the original item. Restoration is different from conservation and the hobby instinctively realizes this. For example, there is a tendency to see “small” amounts of restoration (such as tape removal or the addition of small amounts of glue) as insignificant and hobbyists have begun to routinely not label these procedures as restoration. If the International Institute of Conservation's definitions of restoration or conservation are used, then the difference can often be determined by the intent.

This is not the first attempt at a classification of collectibles. Robert Overstreet has published a grading classification since 1970. While it has undergone some changes over the years, it is still in use. A restoration grading system was first authored by Matt Nelson and published by Robert Overstreet in the 30^{th} edition of the Overstreet Comic Book Price Guide (April 2000). Nelson's system evaluates a restored item based on the amount of restoration, the before and restored grades, the market demand, the market value and the age of the comic. As late as April 2003, his system evaluated a restored item based on the amount of the restoration, the apparent grade of the item (taking into consideration the original, unrestored grade of the item), the market demand, the market value and the age of the item. Also, third-party grading companies have adopted Nelson's system to their own ends, reporting various restoration treatments as a side-note but indicating restored items with a unique label color.

Nelson's system was designed to provide enough information so that monetary value could be assigned to a restored book. It also uses the undefined terms of light, moderate and heavy (which are interchangeable with minor, moderate and major). He attempts to group the amount of restoration based on the reversibility of the treatment. The apparent grade of the item (taking into consideration the original unrestored grade of the item) is used to help in determining how much restoration was performed. An item that was in low condition that is now in high condition has had more work done (or more intrusive work) than one in medium condition that is now in high condition, which is not necessarily true. Market demand and market value are further attempts to arrive at a monetary value for the item, as is age of the item that was restored.

Due to the limited nature of the terms of minor, moderate, major and amateur or professional, a client viewing a book that has been evaluated as Apparent VF-7.5 Moderate (Professional) with additional notes of color touch, pieces added and tear seals might not fully understand what they are viewing or the extent to which an item has been altered. Also, with current systems there is little or no regard for the quality of the materials used.

Currently, a term of minor, moderate or major is awarded based on an arbitrary interpretation of the restoration. It stands to reason that these terms can be interchanged based on the viewer's prejudices as to what constitutes a minor, moderate or major repair or amount of restoration. There is some consideration given to glue repairs as well as markers that have bled through the paper as being amateur, however, consistency with the application of the various restored labels has been questionable.

### SUMMARY OF THE INVENTION

According to a first aspect of the invention, there is provided a method of assessing the quality and quantity of restoration performed on a paper collectible comprising:
analyzing a paper collectible for alterations and assigning a score based on the specific alterations done and the extent thereof;
determining extent of work done to the paper collectible based on a percentage of total material that has been altered and adjusting the score based on said percentage;
determining how apparent the alterations are and adjusting the score based thereon; and
assigning said score to the paper collectible.

According to a second aspect of the invention, there is provided a method of assessing the condition of a paper collectible comprising:
analyzing a paper collectible for alterations;
determining extent of alterations done to the paper collectible based on a percentage of total material that has been altered and assigning a score based on said percentage;
determining how apparent the alterations are and adjusting the score based thereon; and
assigning said score to the paper collectible.

### DESCRIPTION OF THE PREFERRED EMBODIMENTS

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described. All publications mentioned hereunder are incorporated herein by reference.

As used herein, “paper collectible” includes, for example, comic books, pulp magazines, glossy magazines, paperback books, posters, advertising ephemera, archival collections, historic records, sport and non-sport trading cards, book jackets, record sleeves, postcards, certificates, photographs, maps, newspapers, family documents, original toy and advertising boxes, cereal boxes, prints, original art, works of art on paper and the like.

As used herein, “alterations” refers to any changes to the paper collectible from its original condition. As will be apparent to one of skill in the art, this may include damage due to use, ageing or abuse, as discussed below as well as restoration activities, as discussed below.

As used herein, “extent of alterations” refers to both the quantity, in terms of surface area, of alterations and also the quality, in terms of severity of alterations.

Described herein is a system and a method for assessing the quantity and quality of restoration performed on a paper collectible.

Specifically, in one embodiment, the condition of the paper collectible is reviewed and points are deducted from an initial score of 100 based on one or more of the following: the specific alterations done and the extent of these alterations, the percentage of the paper collectable that has been restored, how visible the restoration work is, what the intent of the restoration was—improving structure or aesthetics, and the quality of the materials used.

As will be appreciated by one of skill in the art, used in this context, terms such as “deducting points”, “adding points”, “adjusting upwards” and “adjusting downwards” are relative terms and should be understood as such within the context in which they are used. As such, scoring systems in which the base score is zero or 50 or another arbitrary number and wherein scores above the base score indicate, for example, increasing degrees of restoration are within the scope of the invention. That is, it is to be understood the score relates directly to the condition of the collectible and indicating that the score is “increased” or “adjusted upwards” indicates that the condition and therefore the value of the collectible is increased, regardless of the actual scoring scale used.

The system and the method will now be described by way of example. As will be appreciated by one of skill in the art, the method may be practiced in a number of ways, for example, using a computer program such as a spreadsheet or other similar software to track scoring or printed sheets or survey may be used. Inquiry of the restoration applied to the item may be by various methods, including verbal questions, printed forms, internet style survey, actual submission of item, or electronic scan and digital analysis etc.

In use, an item is received from the owner. The item is place on a flat surface or held gently in the palm of the hand and beginning with the front cover a quick scan is done (usually starting at the top left corner and proceeding counter clock-wise). Any variances from the original printed condition are noted (either physically written down or mentally inventoried). The item can be held at an angle to a light source to better determine surface gloss and reflectivity and/or any deviances from the original printed condition. The item is then opened and the color and physical condition of the paper is noted. Originally the paper is white, with time it can yellow and age—eventually reaching a brown/ochre color. Color can be an indication of acidity in the paper fibres. Flipping carefully through the pages will reveal any brittleness, edge tears or other damage. The centerfold is inspected to ensure it is present and that the staples holding the entire item are firmly in place and have not pulled through the center folio. Once all interior paper has been scanned and evaluated, then the back cover is evaluated in a similar fashion to the way in which the front cover was evaluated and then the item (as a whole) is assigned a condition grade based on the accumulated list of defects found and their affect on an otherwise perfect example. This is subtractive grading. An alternative is to start at a low condition grade, and proceed to ascertain the highest possible condition grade that the item can reach with the evaluated defects that are present. This is known as additive grading, but is not as prevalent.

All evaluations are performed under available light conditions; however, alternative light sources are very helpful. Incandescent, fluorescent and ultra-violet black light are very helpful in revealing alterations that would otherwise not be detectible. Also, raking light (which is light cast across the flat surface of an item at a low angle) and transmitted light (light that comes through the item from behind) will reveal many further alterations to the original item including planar deformations and “invisible” repairs that have either added material and/or increased the items' density.

Both unrestored and restored items are graded in this way. Restored items are graded with increased vigilance on the staple areas and spine areas of the item, as structurally, these are the weakest areas and most probably altered.

As an item is evaluated it becomes possible to gain an understanding of the various influences on the items' condition. Each tear is testament to the items' storage during the years, as is each piece replacement, fold, crease or chip.

An Evaluation (Grading) System for Use on Either Unrestored or RestoredPaper Collectibles.

Using the process of evaluation as described above, an item is received from a client and evaluated. The variations from ideal condition are recorded on paper or electronically. Using a scored questionnaire, spreadsheet, or similar program, the total variations are determined, scored, & tabulated and an equivalent percentage subtracted from the base of 100%. The end result is a numerical scoring of the item and an equivalent percentage of the original that remains (i.e. 5 and the percentage of 95%).

Depending on the collectible item being evaluated, the terminology would be different and the criteria scored differently. For example a trading card printed on 2 sides would be affected differently than a magazine of 2 types of paperstock and several folios.

Classification of Treatments

In restoration, there are numerous procedures that can be utilized to treat an item. Those procedures can be classified into 19 basic steps that can be implemented. Several steps over-lap, but the list comes down to these basic 19 (in alphabetical order):

BLEACHING—the whitening of darkened pages using chemicals.

DRY CLEANING—the use of soft abrasives (such as powdered erasers) to remove surface dirt from the item.

COLOUR MATCHING—the use of materials to improve the aesthetic appearance of damaged areas or of repaired areas by recreating artwork, texture or colour.

CONSOLIDATION—any treatment that attempts to re-adhere loose or detached pieces to the original support using adhesives or tissues coated with adhesives.

DEACIDIFICATION—once again, the neutralization of acids to prevent the browning of paper pages altering the current state of the item by raising acidity to a higher (if not alkaline) level (pH of 7 or greater).

INFILLING—the infilling of missing areas (including artwork) using matching papers and/or similar materials

INK REMOVAL—the use of chemical solvents to remove ink from an item's surface

PRESSING—the use of pressure (usually in combination with other processes) to flatten and return an item to its original state

REGLOSSING—the use of organic or manufactured substances to recreate surface texture.

REINFORCEMENT—the addition of material to prevent or protect the item from future damage.

RESIZING—the use of organic or manufactured substances to recreate paper strength and flexibility.

SOLVENT CLEANING—the use of organic solvents to remove staining or discoloration from the surface of an item.

SPINE ROLL REMOVAL—the use of pressure (usually in combination with other processes) to flatten and return an item to its original state by removing a rolled spine

STAPLE CLEANING—the removal, through mechanical and solvent methods, of discoloration products found on metallic staples

STAPLE REPLACEMENT—the removal of rusted or damaged staples in order to replace them with new stainless steel staples of a similar size and/or thickness.

TAPE REMOVAL—through the use of mechanical methods or solvents, tape can be removed from the surface of an item.

TEAR REPAIRS—similar to consolidation, the repair of torn areas using adhesives or additional papers coated with adhesives

TRIMMING/SHAVING—the alteration of an item's dimensions and shape using a mechanical device such as a blade, scalpel or file.

WASHING—similar to cleaning, uses a variety of solutions (including solvents) in an aqueous treatment of the item

Of these 19 steps, some are clearly restoration while others would result in the pure conservation of the item (that is, the prevention of existing damage from proceeding further). Still others cannot be classified as conservation or restoration until one examines the intent behind the treatment because those procedures fulfil both a conservation and restoration requirement. Breaking them down, the analysis of each procedure results in a table:

| Procedure | Conservation? | Restoration? | Both? |
|---|---|---|---|
| BLEACHING | | Y | |
| DRY CLEANING | | | Y |
| COLOUR MATCHING | | Y | |
| CONSOLIDATION | Y¹ | | |
| DEACIDIFICATION | Y | | |
| INFILLING | | Y | |
| INK REMOVAL | | Y | |
| PRESSING | | | Y |
| REGLOSSING | | Y | |
| REINFORCEMENT | Y¹ | | |
| RESIZING | | Y | |
| SOLVENT | | Y | |
| CLEANING | | | |
| SPINE ROLL | | | Y |
| REMOVAL | | | |
| STAPLE CLEANING | | | Y |
| STAPLE | | Y | |
| REPLACEMENT | | | |
| TAPE REMOVAL | | | Y |
| TEAR REPAIRS | Y¹ | | |
| TRIMMING/SHAVING | | Y | |
| WASHING | Y | | |

Y¹—Becomes Both Restoration and Conservation when an Attempt is Made to Cover the Repair by Adding Colouring Materials the Restoration System

Using the above 19 procedures as a working basis, a point system was created for each procedure. Points were assigned based on a survey of retailers and collectors from all over the world and an average value taken. Points were assigned based on the amount of alteration each procedure incurred to an original book, with −5 being the most alteration and 0 being little or no discernable alteration. There was no consideration towards proficiency of technique or quality of the materials used. This reduces, in effect, the various procedures to a yes or no in the equation, as either a treatment has been performed or it has not, and the scoring count is applied accordingly. The −5 to 0 valuation could be adjusted to refine the affective score as additional data is compiled and analysed.

Based on completed interviews and surveys the sample scoring system currently used in a preferred embodiment of our invention is as follows:

| Procedures | Count |
|---|---|
| Cleaning | −1 |
| Washing | −1 |
| Bleaching | −4 |
| Deacidification | −1 |
| Consolidation | −3 |
| Reinforcement | −3 |
| Tear Repairs | −2 |
| Infilling | −4 |
| Spine Roll Removal | −1 |
| Pressing | 0 |
| Staple Cleaning | −1 |
| Staple Replacement | −2 |
| Color Matching | −4 |
| Resizing | −4 |
| Reglossing | −4 |
| Tape Removal | −2 |
| Trimming/Shaving | −5 |
| Ink/Writing Removal | −2 |
| Solvent Cleaning | −2 |

As will be appreciated by one of skill in the art and as discussed below, a suitable scoring system for any specific paper collectible may include one or more, two or more, three or more, four or more or five or more of the above criteria. As discussed above, different criteria may be weighted differently for different collectibles. For example, cereal boxes and collectible cards do not contain staples and therefore this criteria would be eliminated (and in some embodiments, more relevant criteria inserted) in the scoring system for these items.

This resulted in a scale where Pressing as a procedure is considered the least intrusive, while Trimming/Shaving of the item is the most intrusive. The more intrusive and altering procedures of bleaching, piece replacement, color-matching, resizing and reglossing rated on par with trimming and shaving of original paper.

Other factors impact upon an item's originality. The system allows for additional numerical values based on the amount of the restoration performed and to this end, the system has included a category for the Extent of Work (% of entire item showing work). This category addresses the arbitrary assignment of the terms minor, moderate and major. In fact, this was the goal of the system itself and in the place of undefined terms such as minor, moderate and major the new system uses a calculable percentage of the overall item creating an overall scoring based on the extent of the work performed and how much of the original book remains. Based on data to date the sample scoring system currently used in a preferred embodiment of our invention is as follows:

| | | |
|---|---|---|
| <5% | −1 | Golden Age Cover has 148.63 square inches |
| 5-10% | −5 | Golden Age book, 2526.63 square inches (17 folios) |
| 10-15% | −10 | Silver Age Cover has 143.50 |
| 15-20% | −15 | Silver Age book has 1291.5 (9 folios) |
| 20-25% | −20 | |
| 25-30% | −25 | |
| 30-35% | −30 | |
| 35-40% | −35 | |
| 40-45% | −40 | |
| 45-50% | −45 | |
| >50% | −50 | |

For example, if the work has been performed to only one area of the cover, then it only stands to reason that the item (and therefore the overall score) is less affected than if the entire 17 folios (16 interior, 1 cover) have been treated. This allows for the objective scoring of the restoration based on the extent to which restoration has been performed eliminating vague references to undefined terms which are currently in use. It also creates a system where the same score can be awarded each and every time a book is examined. In effect, less is more and this category of the scoring system reflects that notion.

When a restored book is presented to a viewer, the first inclination is not to examine what was done but is instead to note how obvious the repair work appears to be. Is it, in the eye of the viewer of (to use the current terms) amateur or professional level? If a repair or treatment is obvious, then the work is often labelled as amateur. Professional restoration is then, by default, hard to detect by the average person. While these terms are appropriate, they are appropriate to a very limited degree. The immediate problem of using such judgemental terms as amateur and professional is that it tries to account for treatments done by an “amateur” based on the restorers ability to mask the work done. The system offers a replacement of the inferior terms “amateur” or “professional” which is currently in widespread usage by quantifying the obviousness of the work done under the more appropriate title of Evidence of Work.

Evidence of Work

| | |
|---|---|
| >arm's length | −25 |
| arm's length | −15 |
| 2-3 feet | −10 |
| 1-2 feet | −5 |
| 0-1 foot/device needed | 0 |
| Device needed | 5 |

Under this section, the final appearance of the restoration is evaluated under a form of the museological standard known as ‘arm's length’. This original standard states that the work must not be visible beyond arm's length but readily discernable at closer than arm's length. It exists to satisfy the needs of the viewing public by making the restoration work appear to be original but at the same time, it satisfies the needs of the conservation professional by having the work readily detectible from the original in case repairs or alterations to the restoration are necessary. However, the collecting market has even more stringent guidelines and to be labelled as professional, the restoration work must not be visible at anything more than 12″ from the viewer or should only be detected if some sort of device is used like a magnification loupe or alternate light source. Any work that is clearly visible beyond the 12″ distance would be currently labelled as amateur. A category based solely on Evidence of Work, eliminates any arbitrary judgement on the work performed as the work is evaluated to be highly evident, slightly evident or barely evident with points assigned appropriately.

A separate section was created within the system to account for the materials used in the treatment of an item. Since inferior and/or inappropriate materials can and are used by the restoration community, there is clearly a need to create a scoring system that takes into account the quality of the materials used. Those materials are rated as being beneficial, harmful, both or unknown. Determining the materials used is quite easy to those persons with proper training even without proper documentation. However, since there are some “trade secrets” amongst the various restorers in the hobby, the categories of both and unknown were added to quantify uncertain materials. The scoring for this section is as follows:

Materials Used

| | |
|---|---|
| Beneficial | 10 |
| Harmful | −10 |
| Both | −5 |
| Unknown | −15 |

As mentioned, restoration treatments count as restoration or conservation depending, in large part, on the intent of the conservator/restorer/client in having the procedures implemented.

The Intent of the work that is performed can be broken down into one of three choices:
1) the work was done to the paper collectible to improve the structural stability of the item only
2) the work was done to the paper collectible to improve the esthetics of the item only or
3) the work was done to improve both the esthetics and the structure of the item.

We feel, as do our survey correspondents, that work that is structural should not adversely affect the overall score while work that was performed only to enhance esthetics of the item should be scored more severely. The following scores were generated:

Intent of the work

| | |
|---|---|
| improve structural only | 10 |
| improve esthetics only | −10 |
| improve both | −5 |

Intent can be deduced through the examination of the item and surveying the various treatments that were performed. However, in order to know the exact intent of the conservator/restorer/client in restoring an item, proper documentation of the various procedures is vital. Documentation, whether it be written, photographic or both, not only serves to inform the general public about what was done but also provides invaluable information to other conservators or restorers seeking to treat the already treated item. Unfortunately, much of the documentation produced by the various studios has been discarded over the years, if indeed any was provided at all. This lack of documentation creates an aura of fear and distrust and perpetuates the myth that all restoration is harmful and must be avoided. When documentation is available, it should be seen as a positive influence on the rating of the item. Thus, the following scores were assigned:

Documentation

| | |
|---|---|
| Written Only | 5 |
| Photos Only | 5 |
| Both | 10 |
| Not available | −10 |

Taken together, a score is generated that takes into account what restoration was done, where was it done, why was it done and how was it done. The end-user can then refer to this number and use it to generate a market value or use it to indicate the present condition of the item in relation to similar items with differing scores.

### The Grading System

A similar system can be created for the grading of collectibles. Simply replacing the terminology and the categories with collectible-specific terms and terminology would allow the software or evaluator to arrive at a similar numerical evaluation. Vague terms such as small crease, tiny chips, etc would need to be further clarified but easily done. An additional component of a digital image would assist in the final evaluation of the item as a proprietary software program could be utilized or created to examine the object for the client, with little or no input from the client.

Our System

While the system was created with restored comic books in mind, it is important to realize that the system of quantifying an item based on a given set of criteria will vary and can be modified depending on the collectible in question. For instance, the initial 19 procedures for restoring a comic book (or paper collectible) can be modified to fit the example of a sports or non-sports trading card. In this example, there is no “spine” on a trading card, so “spine roll removal” is irrelevant. Cards are also different in that they are not held together by staples, so this procedure would not be listed in a system that evaluates the current condition of an ephemeral item. However, greater emphasis is placed on surface gloss, so this point of evaluation (and a new set of corresponding values) would need to be exchanged for those areas not readily relevant to the item being examined. This would also be true of other items, as each item has its own unique set of criteria by which it is evaluated.

As mentioned, this is not the first time that a set of criteria for the classification of collectibles has been created. Overstreet's grading terms (in use since 1970) attempted to organize the various defects that could be found on a comic book and group them under a specific heading, thus giving an indication of overall grade. Originally, the grades were simple (good, fine, mint) but over the years have evolved to include good, very good, fine, fine/very fine, very fine, very fine/near mint and near mint. The criteria for what constitutes a good, very good, etc, has also evolved over the years.

Matt Nelson's article on restored comics (published in April 2000) was simply an attempt to determine the value of restored items by evaluating the amount of restoration present. It takes into consideration the before and restored grades, makes allowances for market demand and market value plus takes into account the age of the restored book. Unfortunately the “before” grade is frequently unknown because documentation is insufficient or missing and the market fluctuates so it's perception of the restoration is inconsistent and not a reliable measure of the item's restoration. His second proposal (published in the Overstreet Comic Book Grading Guide January 2003) expanded on some of the concepts introduced in April 2000, including an attempt to label restoration of comic books into 2 sections: Quality of Work and Quantity of Work. Under Quality of Work, are listed Cleaning, Structural, Aesthetic and under Quantity of Work the same sub-categories are also listed. Within each of these 3 sub-categories, further specific treatments are listed and a score of 1-9 has been assigned to each of the various treatments. Under Quantity of Work, however, the scores are vastly different ranging from a single point (1) to a range from 1-60. In practice, his system scores a book based on his Quality criteria and his Quantity criteria. The Quality score is then averaged by the number of various specific treatments utilized and assigned a rounded whole number integer. To use his published example, 3. The Quantity of Work scores are added and then compared to a chart in order to determine the extent of restoration. The table shows the extent of work can range from slight to extensive. However since the terms used in the chart are not qualified or defined, the assignment of scores is completely arbitrary. Furthermore, Nelson's system creates 2 scores,—the first being the quality of the work (to use his example, 3) but since that number is not directly indicative of the restoration performed, it is unclear if that number should be considered positive or negative. The second score, dealing with Quantity of work produces a number that is linked to a chart. To use his published example, 48. When the chart is referenced, 48 translates into moderate/extensive restoration. Without the chart, the number is without any direct meaning and since the terms “moderate/extensive” are not defined, the buyer is not educated or made aware of what was done to the book, why it was done or what materials were used.

Further to these two published efforts, Human Computing of San Jose, Calif. has created a software program entitled Comicbase. First published in 1992, it was originally designed as a database to track inventory specifically for comic collectors, however recent upgrades to the program have allowed users to grade and evaluate their comic books from a series of drop-down Microsoft Windows-type menus. This allows the user to evaluate different aspects of the cover, spine, interiors and general overall condition including wear and printing quality. As the user selects from a pre-determined list of criteria (for example; under Cover, sub-section Surface Wear, the user has a choice of 5 options including None, Minimal, Minor, Moderate and Extensive) an overall condition grade (similar to Overstreet's labels) is displayed at the bottom of the program window. This grade is fluid, depending on the choices made by the user and is only estimated. It does not reflect or evaluate restoration at all. Upon selecting the submission button, this grade is then entered into the main database program for later reference.

In comparison, our system, while it is a system for the evaluation of an item, does not currently utilize Overstreet's terms of good, very good, etc. Furthermore, Overstreet's criteria for what constitutes a good, very good, etc, is not static or defined. Currently, wording such as “slightest bindery or printing defects”, “inks are bright”, “very slight staple tears”, etc, allows for interpretation and prejudice by the evaluator and accordingly our system was developed to incorporate precisely defined terms in conjunction with a quantifiable method. Our system is consistent and it is designed to assign the same score each and every time a book is examined, regardless of the examiner.

Nelson's current system, is also problematic and vague and was largely developed to provide a valuation for monetary reasons. Our system was expressly designed to provide information about the actual work performed on the book, with a monetary valuation coming second in importance. While his system does attempt to classify the restoration work into Quantity and Quality, it does so based on sub-categories of Cleaning, Structural and Aesthetic. These terms are vague and do not educate the owner or potential buyer entirely about the restoration an item received. Neither is the assignment of numbers concise, allowing for either a 1, 6 or 9 depending on the judgement of the evaluator. Our system, in comparison, is consistent and designed to assign the same score each and every time. Also, Nelson's final determination utilizes the unclear and undefined terms of amateur, professional, minor, moderate and major (or some versions of these terms), thus it lacks consistency and is also subject to prejudices that these words already have attached to them. Lastly, there is no report or list generated from the system—just a final valuation of the item and that valuation is simply a number and a term, both of which are undefined or explanatory (to use his published example, 3 and 48 moderate/extensive.

The software developed by Human Computing is very user friendly, however, our system (in software or program form) allows the user to directly input information based on a series of directed questions. This would allow for a greater range of responses, as compared to the limited nature of a drop-down menu as used by Comicbase. The range of answers in these drop-down menus are also subjective and rely on an opinion of the user. Also, the responses of our system would be more precise than what is currently offered by Comicbase, since the responses are quantifiable. Future embodiments of a software or program form of our system may utilize digital images (or scans) of the item being evaluated, eventually incorporating a program or utility that will evaluate the item automatically for the user. Any responses inputted by the user, would then be incorporated into a final report allowing the user to print a condition label or evaluation paper.

In comparison:

Our system educates and informs the client what exactly has been altered and/or implemented. All procedures are listed, all sections are quantified and no undefined terms exist. It educates the public to a new level of understanding by eliminating the arbitrary assignment of a non-descript label to an item and instead replaces non-descript terms with specific, measurable and quantifiable criteria.

There is no need to guess at the items previous condition as we are evaluating based on what is currently present.

The condition is evaluated regardless of the intrusive nature of any treatment and instead bases an evaluation on what was done, where it was done, how it was done and why an item is in its current condition.

Our system is consistent and it is designed to assign the same score each and every time a book is examined, regardless of the examiner and is interchangeable with a large diversity of items.

Our system can work alone in that it is a complete system that assigns a score to an item based on specific categories. The score given is an indication of the amount, type and extent of the changes on any given item. The score generated can be further interpreted as a multiplier to determine value, only if one so chooses. It is not dependent upon market fluctuations to arrive at a final number.

The system allows for easy comparison between items using a final number and/or a percentage indicator. Current systems do not allow for easy comparison between items.

Our system can use a software component, but with greater detail, and specifics, thus reducing sources of error to a system of checks and balances finally generating a comprehensive report for the client.

Our system is easy to understand, can be applied to any paper collectible, and is applicable throughout any hobby it is utilized in.

The final delivery of the system may be in report form, label form, summarized form, emailed to the user or archived online through an online e-business solution or database. It may also be downloaded from an online database or archive. The final summation of the criteria could be as a single score, multiple scores or individual category scores (in whole or in part).

In another embodiment of the invention, the scoring system is used to evaluate the condition of a paper collectible that has not been restored. As will be appreciated by one of skill in the art, in these embodiments, the collectible must still be examined closely to confirm that no attempts at restoration have been made. Next, the collectible is examined to determine what percentage of the total material has been altered or damaged, as discussed above. Next, the condition of the collectible is assessed, as discussed above. Finally, the collectible is assigned a score as described above.

While the preferred embodiments of the invention have been described above, it will be recognized and understood that various modifications may be made therein, and the appended claims are intended to cover all such modifications which may fall within the spirit and scope of the invention.

1. A method of assessing the condition of a paper collectible comprising:
analyzing a paper collectible for alterations;
determining extent of the alterations done to the paper collectible based on a percentage of total material that has been altered and assigning a score based on said percentage;
determining how apparent the alterations are and adjusting the score based thereon; and
assigning said score to the paper collectible.

2. The method according to claim 1 including the step of determining materials used for the alterations and adjusting the score downward if the materials are harmful to the paper collectible.

3. The method according to claim 1 including the step of determining materials used for the alterations and adjusting the score upward if the materials are beneficial to the paper collectible.

4. The method according to claim 1 including the step of determining materials used for the alterations and adjusting the score downward if the materials are unknown.

5. The method according to claim 1 including the step of adjusting the score upwards if the restoration was to improve structure and stability of the paper collectible.

6. The method according to claim 1 including the step of adjusting the score downwards if the restoration was to improve aesthetics of the paper collectible.
